(19) United States
(12) Patent Application Publication
(10) Pub. No.: US 2017/0107376 A1
(43) Pub. Date: Apr. 20, 2017

(54) MODIFIED ASPHALT BINDERS AND COMPOSITIONS

(71) Applicant: Arizona Chemical Company, LLC, Jacksonville, FL (US)

(72) Inventors: Ryan H. Winship, Savannah, GA (US); Christopher J. Holmes, Pooler, GA (US); David J.C. Broere, Amsterdam (NL)

(73) Assignee: Arizona Chemical Company, LLC, Jacksonville, FL (US)

(21) Appl. No.: 15/392,259

(22) Filed: Dec. 28, 2016

Related U.S. Application Data
(63) Continuation-in-part of application No. 14/364,805, filed on Jun. 12, 2014.
Application No. 14/364,805 is a continuation-in-part of application No. 14/364,862, filed on Jun. 12, 2014.
(60) Provisional application No. 62/273,604, filed on Dec. 31, 2015.

(51) Int. Cl. C08L 95/00

(52) U.S. Cl. CPC C08L 95/005; C08L 2555/64; C08L 2555/34

(57) ABSTRACT

Binder compositions comprising a bituminous binder and a rheology modifier are disclosed. The rheology modifier comprises a blend of a polyol ester and a C₈-C₂₄ free fatty acid component. Asphalt compositions comprising the modified binder compositions are also disclosed. The rheology modifiers help to improve the high-temperature properties of bituminous binders without sacrificing low-temperature performance. The modified binders and asphalt compositions expand the utility of reclaimed asphalt, including reclaimed asphalt shingles and reclaimed asphalt pavement, thereby helping the road construction industry reduce its reliance on virgin, non-renewable materials.

### CROSS-REFERENCE TO RELATED APPLICATIONS

This application claims priority from U.S. Provisional Application No. 62/273,604, with filing date of Dec. 31, 2015, the entire disclosures of which is incorporated herein by reference for all purposes. This application is also a continuation-in-part of U.S. application Ser. Nos. 14/364,805 and 14/364,862, both with a filing date of Apr. 25, 2013, the entire disclosures of which are incorporated herein by reference for all purposes.

### FIELD

The disclosure relates to additives for use with asphalt binders for road paving and other applications.

### BACKGROUND

Reclaimed asphalt includes reclaimed asphalt pavement (RAP), reclaimed asphalt shingles (RAS), asphalt reclaimed from plant waste, and asphalt recovered from roofing felt, among other sources. Recycled asphalt pavement is typically limited to use as sub-surface “black rock” or in limited amounts in asphalt base and surface layers because, over time, asphalt loses flexibility, becomes oxidized and brittle, and tends to crack, particularly under stress or at low temperatures. The effects are due to aging of the organic component of the asphalt, e.g., the bitumen-containing binder, particularly upon exposure to weather. The aged binder is also highly viscous. Consequently, reclaimed asphalt pavement has different properties than virgin asphalt and is difficult to process. Untreated RAP can be used only sparingly; generally, an asphalt mixture comprising up to 30 wt. % of RAP can be used as sub-surface black rock. Moreover, because of the higher demands of the pavement surface, untreated RAP use there is generally limited to 15-25%.

RAS are generally recovered from two sources: production waste from shingle manufacture and waste streams of end-of-life shingles. These shingles contain a bituminous binder that can be recovered and reused. Binder reclaimed from production waste is soft, unoxidized, and still contains low-molecular-weight, volatile components. However, the binder recovered from used shingles—by far the greater volume of recovered binder—is oxidized, devoid of volatile components, and hardened by weathering and aging. Re-use of this aged binder requires rejuvenation.

It has been disclosed that RAP binders can be modified using ester-functional compositions derived from tall oil (see US2015/0240081 and WO2013/090283). In some cases, the ester-functional compositions could be made from dimerized fatty acids or by-products of the dimerization process, including “Monomer” (or “Monomer acid”) as disclosed in US2015/0240081 and U.S. Pat. No. 7,256,162. Examples of suitable modifiers include ethylene glycol tallate, trimethylolpropane tallate, neopentyl glycol tallate, ethylene glycol Monomerate, and glycerol Monomerate. The ester-functional compositions are desirably made using a thermally stable alcohol such as trimethylolpropane or neopentyl glycol.

US2014/0338565 discloses that certain ester-functional compositions having at least 5 wt. % of cyclic content (aromatic or cycloaliphatic rings) are excellent for revitalizing reclaimed asphalt. These esters or ester blends are derived from aromatic acids, fatty acids, fatty acid monomers, fatty acid dimers, fatty acid trimers, rosin acids, rosin acid dimers, and mixtures thereof. U.S. Pat. No. 4,549,834 discloses that reclaimed asphalt can be blended with virgin asphalt, virgin binder, or both. A variety of rejuvenators or rheology modifiers have been developed to increase the amount of reclaimed asphalt that can be incorporated in both the base and surface layers. Rejuvenating agents restore a portion of the asphalt paving properties and binder bitumen physical properties, such as viscoelastic behavior, so that the reclaimed asphalt properties more closely resemble those of virgin asphalt. Improving the properties of recycled asphalt, and particularly the properties of bitumen binder in RAP and RAS, allows increased amounts of reclaimed asphalt to be used in asphalt mixtures without compromising the properties and lifetime of the final pavement.

Commonly used rejuvenating agents for reclaimed asphalt include low-viscosity products obtained by crude oil distillation or other hydrocarbon oil-based materials (see, e.g., U.S. Pat. Nos. 5,766,333 or 6,117,227). Rejuvenators or rheology modifiers of plant origin have also been described. See, for example, U.S. Pat. No. 7,811,372 (rejuvenating agents comprising bitumen and palm oil); U.S. Pat. No. 7,008,670 (soybean oil, alkyl esters from soybean oil, and terpenes used for sealing or rejuvenating); U.S. Pat. Publ. No. 2010/0034586 (rejuvenating agent based on soybean, sunflower, rapeseed, or other plant-derived oils); and U.S. Pat. Appl. Publ. No. 2008/0041276 (plasticizers for recycled asphalt that may be vegetable oils or alkyl esters made from vegetable oils). U.S. Pat. No. 8,076,399 describes a binder composition comprising a resin of vegetable origin, a vegetable oil, and a polymer having anhydride, carboxylic acid, or epoxide functionality, but this binder is not specifically taught for rejuvenation. Although vegetable oils can provide desirable softening of aged binders, they are prone to leaching from the rejuvenated asphalt.

Various fractions isolated from crude tall oil (CTO) distillation have been used in asphalt compositions, although they are not specifically taught for rejuvenation or rheology modification. See, for instance, U.S. Pat. Appl. Publ. No. 2010/0170417 (CTO distillation fractions as cutting solvents use in asphalt compositions); U.S. Pat. No. 8,034,172 (distilled or oxidized tall oil components for use in asphalt compositions); and U.S. Pat. Nos. 4,479,827 and 4,373,960 (patching compositions comprising asphalt, tall oil, and possibly an organopolysiloxane).

Improved rheology modifiers for bituminous binders are needed. In particular, the industry needs additives for reclaimed asphalt that can improve rutting resistance while maintaining good low-temperature cracking resistance and fatigue cracking resistance. Better rheology modifiers would reduce the cost of road construction by enabling greater use of reclaimed asphalt, especially RAS and RAP, in new pavements and reducing reliance on virgin, non-renewable binder and aggregate materials. A desirable rheology modifier would reduce the viscosity of aged binders to a level comparable to that of virgin binder and would allow for softer, more easily processed asphalt mixtures. Ideally, the rheology modifier would derive from renewable resources, would have good thermal stability at the elevated temperatures normally used to mix and lay asphalt, and could restore the original performance grading to the binder.

### SUMMARY

In one aspect, the disclosure relates to a modified binder composition. The binder composition comprises a bituminous binder and a rheology modifier. In one embodiment, the rheology modifier is present in an amount of 0.05 to 20 wt. % of the binder composition. The rheology modifier is a blend comprising 5-50 wt. % of a polyol ester and C8-C24 free fatty acid component. In one embodiment, the free fatty acid component may have an acid value of at least 180 mg KOH/g. In another embodiment, the free fatty acid may include unsaturated fatty acids and their mixtures in an amount of at least 50% based upon the weight of the free fatty acid.

In another aspect, the disclosure relates to asphalt compositions comprising aggregate and the modified binder compositions.

In some aspects, the polyol ester is based on a polyol having high thermal stability. In other aspects, the free fatty acid component comprises tall oil fatty acid.

### DETAILED DESCRIPTION

The following terms will be used throughout the specification and will have the following meanings unless otherwise indicated.

“Asphalt” refers to a composite material comprising a bituminous binder and aggregate, which is generally used for paving applications. Such asphalt is also known as “asphalt concrete.” Examples of asphalt grades used in paving applications include stone mastic asphalt, soft asphalt, hot rolled asphalt, dense-graded asphalt, gap-graded asphalt, porous asphalt, mastic asphalt, and other asphalt types. Typically, the total amount of bituminous binder in asphalt is from 1 to 10 wt. % based on the total weight of the asphalt, in some cases from 2.5 to 8.5 wt. % and in some cases from 4 to 7.5 wt. %.

“Aggregate” (or “construction aggregate”) is particulate mineral material suitable for use in asphalt. It generally comprises sand, gravel, crushed stone, and slag. Any conventional type of aggregate suitable for use in asphalt can be used. Examples of suitable aggregates include granite, limestone, gravel, and mixtures thereof.

“Bitumen” refers to a mixture of viscous organic liquids or semi-solids from crude oil that is black, sticky, soluble in carbon disulfide, and composed primarily of condensed aromatic hydrocarbons. Alternatively, bitumen refers to a mixture of maltenes and asphaltenes. Bitumen may be any conventional type of bitumen known to the skilled person. The bitumen may be naturally occurring. It may be crude bitumen, or it may be refined bitumen obtained as the bottom residue from vacuum distillation of crude oil, thermal cracking, or hydrocracking.

Performance Grade” (PG) is defined as the temperature interval for which a specific asphalt product is designed. For example, an asphalt product designed to accommodate a high temperature of 64° C. and a low temperature of −22° C. has a PG of 64-22. Performance Grade standards are set by the National Committee of Highway and Roadway Professionals (NCHRP).

The bitumen may be commercially available virgin bitumen such as paving grade bitumen, e.g. bitumen suitable for paving applications. Examples of commercially available paving grade bitumen include, for instance, bitumen which in the penetration grade (PEN) classification system are referred to as PEN 35/50, 40/60 and 70/100 or bitumen which in the performance grade (PG) classification system are referred to as PG 64-22, 58-22, 70-22 and 64-28. Such bitumen is available from, for instance, Shell, Total and British Petroleum (BP). In the PEN classification, the numeric designation refers to the penetration range of the bitumen as measured with the EN 1426 method, e.g., a 40/60 PEN bitumen corresponds to a bitumen with a penetration which ranges from 40 to 60 decimillimeters (dmm). In the PG classification (AASHTO MP 1 specification), the first value of the numeric designation refers to the high-temperature performance and the second value refers to the low-temperature performance as measured by a method which is known in the art as the Superpave^{SM} system.

The bitumen may also be contained in or obtained from reclaimed asphalt shingles or reclaimed asphalt pavement, and is referred to as bitumen of RAS or RAP origin, respectively.

“Binder” refers to a combination of bitumen and, optionally, other components such as elastomers, non-bituminous binders, adhesion promoters, softening agents, or other suitable additives. Useful elastomers include, for example, ethylene-vinyl acetate copolymers, polybutadienes, ethylene-propylene copolymers, ethylene-propylene-diene terpolymers, butadiene-styrene block copolymers, styrene-butadiene-styrene (SBS) block terpolymers, isoprene-styrene block copolymers and styrene-isoprene-styrene (SIS) block terpolymers, or the like. Cured elastomer additives may include ground tire rubber materials. In one embodiment, the additional additives may be added to an asphalt binder in amounts ranging from about 0.1 wt. % to about 10 wt. %. The term bitumen is sometimes used interchangeably with binder.

“Recovered binder” or “reclaimed binder” refers to aged binder that is present in or is recovered from reclaimed asphalt. Normally, the recovered binder is not isolated from the reclaimed asphalt. Recovered binder has a high viscosity compared with that of virgin bitumen as a result of aging and exposure to outdoor weather.

“Aged binder” includes recovered or reclaimed binder and laboratory-aged binder. Aged binder can also refer to hard, poor-quality, or out-of-spec virgin binders that could benefit from combination with a rheology modifier as described herein, particularly virgin binders having a ring-and-ball softening point greater than 65° C. by EN 1427 and a penetration value at 25° C. by EN 1426 less than or equal to 12 dmm.

“Laboratory-aged binder” refers to virgin binder that has been aged using the RTFO (“rolling thin film oven”) and PAV (“pressure aging vessel”) laboratory aging test methods that are known in the art.

“Virgin binder” is binder that has not been used previously for road paving or roofing.

“Virgin bitumen” (also known as “fresh bitumen”) refers to bitumen that has not been used, e.g., bitumen that has not been recovered from road pavement or reclaimed shingles. Virgin bitumen is a component of virgin binder.

“Virgin asphalt” refers to a combination of virgin aggregate with virgin bitumen or virgin binder. Virgin asphalt has not been used previously for paving.

“Reclaimed asphalt” generally includes reclaimed asphalt shingles (RAS), reclaimed asphalt pavement (RAP), reclaimed asphalt from plant waste, reclaimed asphalt from roofing felt, and asphalt from other applications.

“Reclaimed asphalt shingles” (RAS) are asphalt compositions that have been used previously as roofing material or have been recovered as waste from shingle manufacturing. RAS recovered from these sources is processed by well-known methods, including milling, ripping, breaking, crushing, and/or pulverizing.

“Reclaimed asphalt pavement” (RAP) is asphalt that has been used previously as pavement. RAP may be obtained from asphalt that has been removed from a road or other structure, and then has been processed by well-known methods. Prior to use, the RAP may be inspected, sized and selected, for instance, depending on the final paving application.

“Emulsion” generally refers as a multiphase material in which all phases are dispersed in a continuous aqueous phase. The aqueous phase may comprise surfactants, acid, base, thickeners, and other additives. The dispersed phase may comprise thermoplastic natural and synthetic polymers, waxes, asphalt, other additives including rheology modifier(s), optionally petroleum based oils or mixtures thereof, herein collectively referred to as the “oil phase.” High shear and energy can be used to disperse the oil phase in the aqueous phase using apparatus such as colloidal mills.

“Pavement preservation” refers to a proactive maintenance of roads to prevent them from getting to a condition where major rehabilitation or reconstruction is necessary. A pavement preservation application may be any of fog seal, slurry seal, micro-surfacing, chip seal, scrub seal, cape seal, and combinations thereof wherein an asphalt emulsion with optional additives is applied onto an existing road or pavement as a “seal” to seal the surface. In some embodiments, polymer is added to the asphalt emulsion to provide better mixture properties.

“Fog seal” is a pavement preservation application of an asphalt emulsion via a spray application (“fogging”).

“Slurry seal” refers to a pavement preservation application wherein a mixture of water, asphalt emulsion, and aggregate is applied to an existing asphalt pavement surface. A slurry seal is similar to a fog seal except the slurry seal has aggregates as part of the mixture for a “slurry” and slurry seals are generally used on residential streets.

“Microsurfacing” refers to a form of slurry seal, with the application of a mixture of water, asphalt emulsion with additives, aggregate (very small crushed rock), and additives to an existing asphalt concrete pavement surface. A difference between slurry seal and microsurfacing is in how they “break” or harden. Slurry relies on evaporation of the water in the asphalt emulsion. The asphalt emulsion used in microsurfacing contains additives which allow it to break without relying on the sun or heat for evaporation to occur, for the surface to harden quicker than with slurry seals.

“Chip seal” refers a pavement preservation application wherein first asphalt emulsion is applied then then a layer of crushed rock is applied to an existing asphalt pavement surface. “Chip seal” gets its name from the “chips” or small crushed rock placed on the surface.

“Scrub seal” refers to a pavement preservation application that is very close to a chip seal treatment where asphalt emulsion and crushed rock are placed on an asphalt pavement surface. The only difference is that the asphalt emulsion is applied to the road surface through a series of brooms placed at different angles. These brooms guide the asphalt emulsion into the pavement distresses to ensure sealing the road. These series of brooms, known as a “scrub broom”, give the treatment its title, “scrub seal.”

“Cape seal” is a combination of applications, i.e., an application of a chip or scrub seal followed by the application of slurry seal or microsurfacing at a later date.

“Rehabilitation” refers to applications carried out with pavements that exhibit distresses beyond the effectiveness of pavement preservation techniques, but not too severe to warrant the cost of complete reconstruction. As pavement ages, it will deteriorate due to weathering and traffic loading, but not to the point of complete reconstruction, so rehabilitation techniques can be performed.

“Cold in-place recycling” or CIR refers to applications involving a milling machine with a paver mixer, wherein the milling machine breaks and pulverizes a thin amount of the top layer of the old pavement. The material is crushed and screened to the proper size and asphalt emulsions and/or additives including rheology modifiers or rejuvenators are mixed in to rejuvenate the material to give more life. In some applications, virgin aggregate can be added and spread on the existing surface. The material is picked up by the paver and spread, then compacted using known methods, e.g., steel-wheel, pneumatic-tire, or vibratory rollers.

“Rubberized asphalt” refers to an asphalt mix, e.g., hot-mixed asphalt, containing crumb rubber. In some embodiments, the crumb rubber utilized is generated from processing crap tires, wherein the tires are shredded and the steel enforcement and fibers are separated from the rubber. In some embodiments, the crumb rubber serves as a modifier for the asphalt and gives the asphalt greater viscosity and may improve cracking properties.

“Rheology modifier” generally refers to a composition or blend that can be used in asphalt compositions for road and pavement applications including but not limited to new construction, partial or complete re-construction, rehabilitation, preservation, CIR, e.g., in asphalt emulsion compositions, or in combination with aged binder or reclaimed asphalt (or their mixtures with virgin binder and/or virgin asphalt) to modify flow or other properties of the aged binder or reclaimed asphalt and, in some cases, restores some or most of the original properties of virgin binder or virgin asphalt.

Good high-temperature performance is desirable to avoid of rutting, which is a common failure mode for asphalt road surfaces, particularly those that experience high traffic rates or high weight traffic. Combinations of polyol esters and fatty acids such as tall oil fatty acid (TOFA) have not been disclosed for use as rheology modifiers for bituminous binders, including reclaimed asphalt binders. It has been found that rheology modifiers comprising a blend of a polyol ester and a C8-C24 free fatty acid component help improve the high-temperature properties of bituminous binders without sacrificing low-temperature performance, e.g., modifying the binders. In one embodiment with the use of reclaimed (or recycled) asphalt, the modified binders in asphalt compositions expand the utility of reclaimed asphalt thereby helping the road construction industry reduce its reliance on virgin, non-renewable materials.

Rheology Modifier.

The rheology modifier is a blend comprising a polyol ester and a C8-C24 free fatty acid component.

Polyol Ester.

In one embodiment, the rheology modifiers are blends comprising 70 wt. % or less, or 60 wt. % or less, or 2-50 wt. %, 4-50 wt. %, 6-50 wt. %, 8-50 wt. %, 10-50 wt. %, 15-50 wt. % or 20-50 wt. %, of a polyol ester, based upon the weight of the rheology modifier. In other aspects, the balance of the rheology modifier (e.g., 30 wt. % or more, 40 wt. % or more, or 50-98 wt. %, 50-96 wt. %, 50-94 wt. %, 50-92 wt. %, 50-90 wt. %, 50-85 wt. %, or 50-80 wt. % based upon the weight of the rheology modifier) is a C8-C24 free fatty acid component.

Suitable “polyol esters” have an alcohol portion and an ester portion derived from a carboxylic acid, which is typically a fatty acid or a dimerized fatty acid.

The alcohol portion of the polyol ester can be primary, secondary, or tertiary; it can be a monol, diol, or polyol. The alcohol can also derive from polyethers such as triethylene glycol or polyethylene glycols. Phenolate esters are also suitable. Suitable alcohols include, for example methanol, ethanol, 1-propanol, isobutyl alcohol, 2-ethylhexanol, octanol, isodecyl alcohol, benzyl alcohol, cyclohexanol, ethylene glycol monobutyl ether, ethylene glycol, propylene glycol, diethylene glycol, triethylene glycol, neopentyl glycol, glycerol, trimethylolpropane, trimethylolethane, pentaerythritol, dipentaerythritol, sorbitol, sucrose, and the like, and mixtures thereof. In another embodiment, alcohols may be used, also identified herein as “thermally stable” alcohols or polyols, which have a quaternary carbon located beta to the oxygen of any of its hydroxyl groups. Examples include trimethylolpropane, neopentyl glycol, trimethylolethane, pentaerythritol, dipentaerythritol, benzylic alcohols, and the like, and mixtures thereof.

The ester portion of the polyol ester derives from a carboxylic acid, a saturated or unsaturated fatty acid or dimerized fatty acid having 6 to 40 carbons, or 8 to 36 carbons. The ester portion will often comprise a mixture of different fatty acids that are present in natural sources such as animal or vegetable oils.

Suitable polyol esters can be made by reacting the alcohols described above directly with a fatty acid or with lower alkyl esters of the fatty acids and a suitable transesterification catalyst according to well-known methods.

In some aspects, the fatty acid will comprise C8-C24 fatty acids with some degree (in some aspects, a high degree) of unsaturation. The fatty acid can be in a polymerized form, as in dimerized fatty acid mixtures. The fatty acid may comprise one or more of oleic acid, linoleic acid, linolenic acid, and palmitic acid. Also suitable are Monomer acid (defined below), dimer acids, tall oil heads, and the like, and mixtures thereof.

In some aspects, the polyol ester is a reaction product of an alcohol and a tall oil fatty acid (TOFA) or a TOFA derivative (e.g., a TOFA dimer acid). Tall oil fatty acid is isolated from crude tall oil (CTO) by distillation. The CTO is a by-product of the Kraft wood pulping process. Distillation of CTO gives, in addition to tall oil fatty acid, a more volatile, highly saturated fraction of long-chain fatty acids (largely palmitic acid), known as “tall oil heads.” Tall oil fatty acid is the next fraction, which contains mostly C18 and C20 fatty acids having varying degrees of unsaturation (e.g., oleic acid, linoleic acid, linolenic acid, and various isomers of these). Another fraction, known as distilled tall oil or “DTO,” is a mixture of mostly tall oil fatty acid and a smaller proportion of tall oil rosin. Tall oil rosin (“TOR”), isolated next, consists largely of a C19-C20 tricyclic monocarboxylic acid. The bottom fraction of the distillation is known as “tall oil pitch” or simply “pitch.” Generally, any distillation fraction that contains at least some tall oil fatty acid can be used to produce a polyol ester useful herein.

Polymerized fatty acids can be used to make the polyol ester. Unsaturated fatty acids are commonly polymerized using acid clay catalysts. Fatty acids having high levels of mono- or polyunsaturation may also be used. In this process, the unsaturated fatty acids undergo intermolecular addition reactions by, e.g., the “ene reaction,” to form polymerized fatty acids. The product comprises mostly dimerized fatty acid and a unique mixture of monomeric fatty acids. Distillation provides a fraction highly enriched in dimerized fatty acid, commonly known as “dimer acid.” Such dimer acids are suitable for use in making the polyol esters.

The distillation of polymerized TOFA provides a fraction that is highly enriched in monomeric fatty acids and is known as “Monomer” (with a capital “M”) or “Monomer acid.” Monomer, a unique composition, may be used as a starting material for making polyol esters useful herein. Whereas natural source-derived TOFA largely consists of linear C18 unsaturated carboxylic acids, principally oleic and linoleic acids, Monomer contains relatively small amounts of oleic and linoleic acids, and instead contains significant amounts of branched and cyclic C18 acids, saturated and unsaturated, as well as elaidic acid. The more diverse and significantly branched composition of Monomer results from the catalytic processing carried out on TOFA during polymerization. It is recognized that the reaction of Monomer with alcohols to make “Monomerate” esters, yielding derivatives that differ from the corresponding TOFA-based esters. Monomer has been assigned CAS Registry Number 68955-98-6. Examples include Century™ MO5 and MO6 fatty acids from Arizona Chemical Company. U.S. Pat. No. 7,256,162, the teachings of which are incorporated herein by reference, discloses Monomer composition and its conversion to various esters.

Suitable polyol esters include, for example, ethylene glycol tallate (e.g., the ethylene glycol ester of tall oil fatty acid), propylene glycol tallate, trimethylolpropane tallate, neopentyl glycol tallate, methyl tallate, ethyl tallate, glycerol tallate, oleyl tallate, octyl tallate, benzyl tallate, 2-ethylhexyl tallate, polyethylene glycol tallates, tall oil pitch esters, ethylene glycol Monomerate, glycerol Monomerate, trimethylolpropane Monomerate, neopentyl glycol Monomerate, 2-ethylhexyl Monomerate, ethylene glycol dimerate, 2-ethylhexyl dimerate, 2-ethylhexyl trimerate, and the like. In another embodiment, polyol esters may include tallates and Monomerates, especially trimethylolpropane tallate, ethylene glycol Monomerate, neopentyl glycol Monomerate, 2-ethylhexyl Monomerate, and glycerol Monomerate. Suitable polyol esters are commercially available from Arizona Chemical.

In one embodiment, the polyol ester is a reaction product of a thermally stable polyol and at least one molar equivalent of a C8-C24 fatty acid. In one embodiment, the thermally stable polyol is selected from triethylolpropane, trimethylolpropane, neopentyl glycol, pentaerythritol, and mixtures thereof. In yet another embodiment, the polyol ester is made from trimethylolpropane and a tall oil fatty acid.

C8-C24 Free Fatty Acid Component.

In some embodiments, the C8-C24 free fatty acid component is a major constituent, comprising 50-98 wt. %, 50-96 wt. %, 50-94 wt. %, 50-92 wt. %, 50-90 wt. %, 50-85 wt. %, 50-80 wt. %, or 60-80 wt. %, based upon the weight of the rheology modifier.

Suitable C8-C24 fatty acids are well known and commercially available. Suitable fatty acids can be saturated or unsaturated, and they can have linear or branched chains. In some aspects, the fatty acid is a C8-C20 fatty acid, a C10-C18 fatty acid, or a C14-C18 fatty acid. Suitable fatty acids include, for example, caprylic acid, capric acid, lauric acid, myristic acid, palmitic acid, stearic acid, arachidic acid, behenic acid, myristoleic acid, palmitoleic acid, oleic acid, elaidic acid, linoleic acid, conjugated linoleic acid, linolenic acid, erucic acid, and the like, and mixtures thereof. In another embodiment of the present disclosure, unsaturated fatty acids and their mixtures make up the majority of the free fatty acid component (e.g., 50 wt. %, 60 wt. %, 70 wt. %, 80 wt. %, 90 wt. %, 95 wt. % or more, based upon the weight of the free fatty acid component), with the remainder being saturated fatty acids, optionally rosin acids, and unsaponifiables. For vegetable based free fatty acids, the saturated fatty acid content is higher than for tall oil than for pine derived fatty acids. For example, the saturated fatty acid content of tall oil fatty acid may be 10 wt. % or less (or 5 wt. % or less, or from 2 to 10 wt. %) based upon the weight of the free fatty acid, and the saturated fatty acid content of vegetable based fatty acids may be 50 wt. % or less (or 40 wt. % or less, or 30 wt. % or less, or from 5 to 30 wt. %). The unsaponifiables of the free fatty acid may be up to 5 wt. % (or up to 3 wt. %, or from 0.1 to 5 wt. %), and for pine derived fatty acid, rosin acids may be 10 wt. % or less (or 5 wt. % or less, or 3 wt. % or less, or from 1 to 5 wt. %) based upon the total weight of the free fatty acid.

Fatty acid mixtures obtained from natural sources such as animal or vegetable oils, especially vegetable oils, are suitable for use. The fatty acid mixtures are obtained by hydrolysis of natural oils or by transesterification of the oils with a lower alcohol (e.g., methanol, ethanol), followed by saponification of the resulting lower alkyl esters. In another embodiment, the fatty acid is tall oil fatty acid (TOFA) or a mixture of compounds obtained from tall oil (derived from pine) that includes TOFA, e.g., a mixture of TOFA and tall oil fatty acid “heads.” Tall oil fatty acid has a high content of oleic acid and linoleic acid in addition to lesser amounts of saturated fatty acids (e.g., palmitic acid and stearic acid) and other unsaturated fatty acids (e.g., palmitoleic acid, conjugated linoleic acid, and linolenic acid). Tall oil fatty acid is commercially available from Arizona Chemical.

The C8-C24 free fatty acid component has an acid value of at least 190 mg KOH/g as measured by well-known titration methods. When the free fatty acid component includes fatty acids having 20 to 24 carbons, it will normally also have lower fatty acids present such that the acid value of the mixture will be at least 180 mg KOH/g or at least 190 mg KOH/g, or within the range of 180 to 300 mg KOH/g or 190 to 250 mg KOH/g.

In one embodiment, the rheology modifier (e.g., the combination of the polyol ester and the C8-C24 free fatty acid component) has an acid value of 190 mg KOH/g or less, 100 to 190 mg KOH/g, 110 to 180 mg KOH/g, 120 to 170 mg KOH/g, 130 to 160 mg KOH/g or 130 to 145 mg KOH/g.

In some aspects, the rheology modifier has an iodine value within the range of 80 to 200 mg I2/g, or 110 to 160 mg I2/g.

Suitable blends of the polyol ester and the C8-C24 free fatty acid component can be prepared conveniently by reacting an excess of a C8-C24 fatty acid with a polyol such that 50 to 90 wt. % of the resulting product is unreacted C8-C24 fatty acid. For example, reaction of an excess of TOFA with trimethylolpropane provides a mixture of polyol ester from trimethylolpropane and unreacted TOFA, a blend that is well-suited for use as a rheology modifier when the unreacted TOFA is 50 to 90 wt. % of the resulting blend. It is, of course, also possible to prepare the rheology modifier blends by simply combining the polyol ester with the required amount of C8-C24 fatty acid.

### APPLICATIONS

In one embodiment, the rheology modifier is for use in asphalt compositions comprising aggregate and a binder composition for any of new construction, partial or complete re-construction applications. The rheology modifier can be used for any of paved surfaces, road surfaces and sub-surfaces, runways, shoulders, bridges, bridge abutments, gravel substitutes for unpaved roads, and the like. In addition, the rheology modifier can be used in a variety of industrial applications, not limited to coatings, drilling applications, and lubricants.

In one embodiment, the asphalt compositions comprise any of virgin asphalt, reclaimed asphalt, or mixtures thereof. In yet another embodiment, the rheology modifier is for use in asphalt compositions comprising an asphalt emulsion for use in any of rehabilitation, preservation, or CIR applications.

In one embodiment, the rheology modifier is for use in any of a warm-mix composition, a hot-mix asphalt composition, e.g., mixed at a temperature around 300° F.-350° F., which then can be applied to roadways using specialized machines, compacted, and the asphalt hardens as it cools. In another embodiment, the rheology modifier is used in a cold-mix asphalt formulation with aggregate, an emulsion and water.

Rejunevation of Aged Binder/RA—Binder Compositions

In one aspect, the rheology modifier is used in a modified binder composition with reclaimed asphalt suitable for use with asphalt, optionally with virgin binder and aggregate. The binder composition comprises a combination of a bituminous binder and the rheology modifier comprising a blend of a polyol ester and a C8-C24 fatty acid.

Suitable bituminous binders can come from a variety of sources, including reclaimed binders, optional virgin or performance-grade binders, or combinations thereof. In some aspects, the reclaimed binder is from any of reclaimed asphalt pavement (“RAP binder”), reclaimed asphalt shingles (“RAS binder”), or combinations thereof. The bituminous binder can include RAS binder, which is present in or recovered from RAS. Binders reclaimed from production waste during shingle manufacture can also be included. The bituminous binder can include RAP binder, which is present in or recovered from RAP. The bituminous binder can also include virgin binder or performance-grade binders in addition to any reclaimed binder.

The amount of bituminous binder in a reclaimed asphalt composition (RAS or RAP) is generally known from the supplier, but it may also be determined by known methods, e.g., solvent extraction. For instance, a known amount of RAS or RAP may be treated with a suitable solvent, e.g. dichloromethane, to extract the binder. The amount of binder in the extracted fraction can be measured, thereby providing the content of binder in the RAS or RAP. The amount of aged binder in the RAS or RAP depends on the source, age, history, location, any pre-treatment, and other factors. The amount of aged binder in RAS or RAP typically ranges from any of 1 to 35 wt. %, from 2.5 to 8.5 wt. %, and 4 to 20 wt. % based on the total amount of RAS or RAP. In one embodiment of RAP, the amount of aged binder can be up to 10 wt. %. In one embodiment of a RAS, the amount of aged binder is typically in the range of 20-25 wt. %.

In some embodiments, the aged binder is isolated from the reclaimed asphalt by known methods. In other embodiments, the RAS or RAP is combined with a desirable amount of rheology modifier. In yet other embodiments, the rheology modifier is combined and mixed with the bituminous binder, and optionally virgin asphalt and/or RAP or RAS to give a modified asphalt product. In yet other embodiments, a desirable amount of rheology modifier is combined or first blended with virgin bitumen, then subsequently mixed with RAP and/or RAS.

The modified binder compositions comprise any of 0.05 to 20 wt. %, 0.5 to 15 wt. % or 1 to 10 wt. %, of the rheology modifier based on the combined amounts of binder and rheology modifier. The effective amount of rheology modifier needed to rejuvenate the binder in the RAS/RAP varies and depends on the source of the binder, age, its history, and other factors.

In some aspects, the binder composition comprises 50 to 70 wt. % of a performance-grade or virgin binder. In some aspects, the binder composition comprises any of 0.5 to 30 wt. %, 2 to 25 wt. %, or 4 to 15 wt. %, of the virgin binder. In other aspects, the bituminous binder comprises a RAS binder, a RAP binder, or a mixture thereof (100% recycled asphalt and no virgin binder). In some further aspects, the binder comprises a RAS binder.

Evidence of the value of using the rheology modifier in modified binder compositions can be demonstrated with dynamic shear rheometry (DSR) data. Rheology, the study of the deformation and flow of matter, provides a fingerprint of the viscoelastic behavior of a bitumen, whether virgin, aged, conditioned, or treated. This measured behavior is correlated to performance of the bitumen within the aggregate asphalt, and subsequently to the performance of the road. The tests performed function based on the principles of linear viscoelasticity and the superposition principle, where strain on a material is proportional to the stress received. A stress is applied to the sample and the response and delay of that response (phase angle) are analyzed and used to calculate moduli that represent different properties of the sample.

It is found that by combining bituminous binders with a rheology modifier comprising a blend of a polyol ester and a C8-C24 fatty acid, the high-temperature properties of the binders can be improved with minimal impact on low-temperature performance. In one example, by combining 10 wt. % of a 75:25 (w/w) blend of a tall oil fatty acid and a polyol ester made from trimethylolpropane and tall oil fatty acid with reclaimed RAS binder, a desirable impact on reducing the temperature at which the rheological high-temperature criteria is satisfied when compared with the results from either rheology modifier alone (see Table 1 results, below).

In examples with RAS binder as shown in Tables 2 and 3, the intermediate-temperature performance of the RAS binder can be altered from unacceptably high to desirably low by including, e.g., 10 wt. % of the rheology modifier blend. Moreover, the rheological intermediate-temperature criteria is satisfied with a 6° C. improvement over the results with 10 wt. % of either rheology modifier component used alone, demonstrating synergy from the modifier blend.

Modified bituminous binder can also be used to improve the high-temperature performance of certain grades of asphalt binders without sacrificing low-temperature performance. As shown in Table 4, a performance-grade binder can be modified by including up to 20 wt. % RAP binder. In one example, an additional 20 wt. % of RAS binder can be included if a small proportion of the above-described rheology modifier blend (combination of 75% tall oil fatty acid and 25% TMP tallate) is also included. Divergence of G* values in the range of 40° C. to 70° C. (Table 4) indicates an advantage in high-temperature performance from the RAS-containing blend (note the 6° C. increase in temperature at G*=1.0×103 Pa). Superimposable values of G* at the low temperature end indicate that low-temperature performance will likely be retained despite the addition of 20 wt. % RAS binder to the blend. The improvement at the high-temperature end (Table 5) and the similar rheological profile at lower temperatures (Table 4) suggest an improvement in rutting resistance from the blend containing RAS and rheology modifier without a trade-off in fatigue or low-temperature performance.

Methods for Forming Binder Compositions and Application:

In some embodiments, binder and asphalt compositions can be made by combining components in any desired order. In one convenient approach, an asphalt composition is made by combining rheology modifier with virgin binder, then blending the resulting mixture with reclaimed asphalt, e.g., RAS and/or RAP. In another approach, an asphalt composition is made by combining rheology modifier with RAS and/or RAP, optionally with virgin asphalt.

In one aspect, the asphalt composition comprises aggregate, RAS and/or RAP, and the rheology modifier blend described above, wherein the asphalt composition further comprises virgin asphalt. The virgin asphalt comprises virgin binder and virgin aggregate. The asphalt composition comprises 1 to 99 wt. % of virgin aggregate based on the combined amounts of virgin asphalt, RAS, RAP, and rheology modifier blend.

In another aspect, the asphalt composition comprises aggregate, RAS and/or RAP, and the rheology modifier. Together, the RAS/RAP binder and the rheology modifier blend form a modified binder having a PG grade at least one grade lower than that of the RAS binder without the rheology modifier. For example, a shift in the PG grade from PG 76-22 to PG 70-22 or from PG 64-22 to PG 58-22 represents a one-grade reduction.

Polymer Compatiblization in Asphalt Compositions.

Asphalt is often modified with elastomeric and plastomeric polymers such as Styrene-Butadiene Styrene (SBS) as well as ground tire rubber to increase high temperature modulus and elasticity, to increase resistance to heavy traffic loading and toughening the asphalt matrix against damage accumulation through repetitive loading. Such polymers are usually used at 3 to 7 wt % dosages in the asphalt and can be as high as 20% for ground tire rubber. The polymer is high shear blended into asphalt at high temperatures, e.g., >180° C. and allowed to “cure” at similar temperatures during which the polymer swells by adsorption in the asphalt until a continuous phase is achieved. The volume phase of the fully cured polymer will be affected by degree of compatibility of the polymer in the asphalt and the fineness of the dispersed particles.

In one embodiment, the rheology modifier is used to compatibilize polymers and/or ground tire rubber in the asphalt. In one embodiment, the rheology modifier is added and blended into the asphalt before the incorporation of the polymer, or the curing stage.

In one embodiment, the rheology modifier is added to a rubberized asphalt composition in any of a dry process or a wet process. In the dry process, the crumb rubber is combined with a heated aggregate, followed by the addition of the asphalt binder and the rheology modifier. In the wet process, the rheology modifier is mixed with bitumen and rubber particles, or blended separately with bitumen first then mixed together with rubber particles. The rubberized bitumen is then mixed with asphalt. The amount of rubber in the rubberized bitumen (or rubberized asphalt dispersion) is typically in the range of 1 to 25 wt. %. The amount of rheology modifier is typically in the range of 1-10 wt. %. In one embodiment, the rubberized bitumen asphalt dispersion further contains 1 to 10 wt. % of a polyamide stabilizer having an amine number within the range of 50-500 mg KOH/g.

Asphalt Emulsions:

The rheology modifier can also be used in asphalt emulsions for applications including pavement preservation, rehabilitation, and CIR applications. Examples of applications or treatments using asphalt emulsions may include rejuvenating, scrub seal, fog seal, sand seal, chip seal, tack coat, bond coat, crack filler or as a material for prevention of reflective cracking of pavements.

Asphalt emulsions comprise globules of paving asphalt, water, an emulsifying agent or surfactant, and the rheology modifier. The emulsifying agent keeps the paving asphalt globules in suspension until it is applied to the pavement surface when the water in the asphalt emulsion starts to evaporate. In one embodiment, the emulsifying agent provides a cationic, anionic, non-ionic, or neutral character to the final emulsion depending upon the desired emulsion's electrochemical properties or the intended emulsion use, for example, the surface type on which the asphalt emulsion is to be applied. The rheology modifier functions to slightly soften the pavement to create a better bond when applied to an existing pavement. Asphalt emulsions can optionally include a latex dispersion, e.g., a SBR latex dispersion as disclosed in U.S. Pat. No. 7,357,594, incorporated herein by reference.

In one embodiment, the rheology modifier is used in a polymer-modified asphalt rejuvenating emulsion, which comprises an asphalt phase with an asphalt and the rheology modifier, and an aqueous phase comprising water, a polymer or copolymer (e.g., acrylics such as polychloroprene, copolymers such as styrene-butyl acrylate copolymer) and an emulsifying agent. Examples of polymers or copolymers that can be used in the asphalt emulsion are disclosed in U.S. Pat. No. 8,821,064, incorporated herein by reference. The surfactant comprises from about 0.01% to about 3.0% of the total weight of the emulsion. The polymer or copolymer is about 1% to about 15% of the total weight of the emulsion. The asphalt phase comprises from about 30% to about 70% of the total weight of the emulsion. The rheology modifier comprises about 0.1% to about 15% of the total weight of the emulsion. The ratio of the rheology modifier to the polymer or copolymer may for example be from 1:10 to 5:1, from 1:3 to 3:1, from 1:2 to 2:1, or about 1:1. In one embodiment, the surfactant comprises about 5-30 wt. % of the rheology modifier.

Depending on the type of emulsifying agent used, e.g., cationic, anionic, amphoteric and non ionic, an acid or a base may be needed to activate the emulsifying agent. In one embodiment with cationic emulsifying agents, acid may be added to adjust the emulsion pH to between 1.0 and 7.0. Suitable acids include inorganic acids, for example hydrochloric acid and phosphoric acid. In some embodiments with anionic emulsifying agents, base may be added to adjust the emulsion pH to between 7.0 and 12.0. In some embodiments with amphoteric emulsifying agents, both the cationic and anionic chemical functionality are built into the same molecule. Therefore, either functionality may be activated; the cationic portion may be activated by acid or the anionic portion may be activated by base. A sufficient amount of emulsifying agent is used maintain a stable emulsion, e.g., from 0.01 to about 5% by weight of the emulsion, from 0.1% to about 3.0% by weight of the emulsion. Examples of emulsifying agents are disclosed in US Patent Publication No. 2014/0230693, incorporated herein by reference.

Exemplary cationic emulsifying agents include polyamines, fatty amines, fatty amido-amines, ethoxylated amines, diamines, imidazolines, quaternary ammonium salts, and mixtures thereof. Exemplary anionic emulsifying agents include alkali metal or ammonium salts of fatty acids, alkali metal polyalkoxycarboxylates, alkali metal N-acylsarcosinates, alkali metal hydrocarbylsulphonates, for example, sodium alkylsulphonates, sodium arylsulphonates, sodium alkylarylsulphonates, sodium alkylarenesulphonates, sodium lignosulphonates, sodium dialkylsulphosuccinates and sodium alkyl sulphates, long chain carboxylic and sulphonic acids, their salts and mixtures thereof. Exemplary amphoteric emulsifying agents include betaines and amphoteric imidazolinium derivatives. Exemplary non-ionic emulsifying agents include ethoxylated compounds and esters, for example ethoxylated fatty alcohols, ethoxylated fatty acids, sorbitan esters, ethoxylated sorbitan esters, ethoxylated alkylphenols, ethoxylated fatty amides, glycerine fatty acid esters, alcohols, alkyl phenols, and mixtures thereof. In one embodiment, the emulsifying agent is an alkoxylated fatty amine surfactant.

Method for Forming & Applications of Asphalt Emulsions:

In one embodiment for making an asphalt emulsion (aqueous dispersion), a binder composition is first heated so that it melts, the rheology modifier is added, then an emulsifying solution comprising water and emulsifying agent is added to the molten binder composition. The emulsifying solution and the molten binder are mixed under high shear (e.g. in a colloid mill) to form an emulsion.

The final asphalt emulsion may be applied by hand spreading, conventional spreading, spraying, or other techniques, then letting the emulsion dry. A recommended application rate may be, for example, about 0.045 to about 2.7 liters/sq. meter (about 0.01 to about 0.60 gal/sq. yd.) or about 0.14 to about 2.0 liters/sq. meter (about 0.03 to about 0.45 gal/sq. yd.). In one embodiment, the complex modulus of the dried composition is 2.3 kPa at 50° C. after 3 days curing.

### EXAMPLES

The following examples merely illustrate the disclosure. The skilled person will recognize many variations that are within the spirit of the disclosure and scope of the claims.

Isolation of RAS Binder from Reclaimed Asphalt Shingles.

Extraction of the RAS binder was performed per ASTM D2172, Standard Test Methods for Quantitative Extraction of Bitumen from Bituminous Paving Mixtures. The binder was recovered from the extracted residue as per ASTM D7906.

Preparation of Polyol Tallate.

A one liter four-necked reaction flask equipped with a thermocouple/nitrogen blanket combination, an overhead stirrer, a sampling port, and a takeoff to collet water of reaction was charged with 500.0 g of TOFA, 85.5 g of polyol, and 0.27 g of esterification catalyst. Nitrogen blanketing was set to 0.1 L/min and agitation was set to 275 RPM. The temperature was set to 180° C. and was achieved after approximately 50 minutes. The temperature was then set to increase to 250° C. at a rate of 35° C./hour. The reaction was maintained at 250° C. and sampled until the acid value specification of 15 mg KOH/g maximum was met and then cooled immediately.

Blends of RAS Binder with Rheology Modifiers.

Blends of RAS binder with rheology modifiers were done by placing 2.0 g of RAS binder and a sufficient amount of rheology modifier in a 2 oz. glass jar. Percent rheology modifier is determined by percent mass of binder (ex. 0.20 g rheology modifier into 2.0 g of binder equals 10% rheology modifier). The jar was then placed in an oven at 177° C. along with a metal spatula to pre-heat for approximately 20 minutes. The binder was stirred with the preheated spatula for 30 seconds and returned to the oven for another 20 minutes. The binder was stirred again for 30 seconds and then poured out to be tested via Dynamic Shear Rheometry (“DSR”).

Evaluation of Intermediate and High-Temperature Performance of RAS Binders+Rheology Modifiers by DSR.

Samples of RAS binder containing 10 wt. % of rheology modifiers prepared as described above are evaluated for intermediate and high-temperature properties using DSR.

Dynamic shear moduli are measured using 8-mm diameter parallel plate geometries with a TA Instruments AR-G2 rotational dynamic shear rheometer. Temperature sweeps are performed at 2° C. intervals over a temperature range of −15° C. to 200° C. at a rate of 6° C./minute and an angular frequency of 10 rad/sec. Initially the temperature sweep maintains a constant torque of 5000 μNm up until the point at which the percent strain of the sample reaches 15%, at which time the percent strain is then held constant at 15%.

High- and intermediate-temperature performance parameters, e.g., G*/sin δ and G*sin δ, are calculated from the measured G*, the complex modulus, and δ, delta degrees. The control sample is an extracted RAS binder without added rheology modifier.

Dynamic shear moduli are measured using 8-mm diameter parallel plate geometry with a Malvern Kinexus rotational dynamic shear rheometer. Temperature sweeps are performed at 2° C. intervals over a temperature range of −15° C. to 200° C. and an angular frequency of 10 rad/sec.

Intermediate-Temperature Properties.

Fatigue cracking resistance of an RTFO/PAV (rolling thin film oven/pressure aging vessel) aged asphalt binder can be evaluated using G*sin δ (a fatigue factor). G* represents the binder complex shear modulus and δ represents the phase angle. G* approximates stiffness and δ approximates the viscoelastic response of the binder. Binder purchase specifications typically require the factor to be less than 5000 kPa. The factor is considered a measure of energy dissipation which is related to fatigue damage. The critical temperature range for fatigue damage is near the midpoint between the highest and lowest service temperatures, calculated by the formula,

$$Intermediate Temp . = ( \frac{High PG + Low PG}{2} ) + 4$$

High-Temperature Properties.

High-temperature mechanical properties are evaluated by the parameter G*/sin δ. The factor is an indication of a binder's resistance to rutting. Binder purchase specifications typically require the factor to be greater than 2.2 kPa for RTFO aged asphalt and greater than 1 kPa before RTFO aging. In all of the tested samples, G*/sin δ decreases significantly with addition of the rheology modifier.

Dynamic shear rheometry (DSR) can be used to evaluate asphalt products to assess their likely performance at low, ambient, and elevated temperatures. At low temperatures (e.g., −10° C.), road surfaces need cracking resistance. Under ambient conditions, stiffness and fatigue properties are important. At elevated temperature, roads need to resist rutting when the asphalt becomes too soft. Criteria have been established by the asphalt industry to identify rheological properties of a binder that correlate with likely paved road surface performance over the three common sets of temperature conditions. Thus, for low temperatures, the complex modulus (G*) of the modified binder measured at −10° C. can be less than or equal to the value for virgin binder. For 30/50 grade virgin binder, G* at −10° C. is ideally at or below 2.8×108 Pa. At ambient temperatures, the complex modulus of the modified binder can be less than or equal to the value for virgin binder. For 30/50 grade virgin binder, G* at 20° C. is ideally at or below 6.0×106 Pa.

Fatigue Criteria Also Relates to Ambient Temperature Performance.

The product of the complex modulus (G*) and the sine of the phase angle (6) measured at 10 rad/s is determined. The temperature at which the value of G*sin δ at 10 rad/s equals 5.0×106 Pa can be less than or equal to 20° C. for modified binders comparable to 35/50 grade virgin binder.

At high temperatures, the quotient G*/sin δ is of interest. The temperature at which the value of G*/sin δ at 10 rad/s equals 1000 Pa can be reduced for modified binders compared with that of aged binder.

TABLE 1
Summary of Dynamic Shear Rheometry Results: High-Temperature Performance^{‡}

| | | | | | Temperature at which |
|---|---|---|---|---|---|
| | Value of G*/sin δ (kPa) at temperatures 60-180° C. | | | | G*/sin δ at 10 rad/s = |
| | 60° C. | 100° C. | 140° C. | 180° C. | 1.0 kPa (° C.) |
| RAS* | 9.35 × 10³ | 2.52 × 10² | 1.62 × 10¹ | 5.85 × 10⁻¹ | 174 |
| RAS + 10% polyol | 1.45 × 10³ | 7.55 × 10¹ | 5.86 × 10⁰ | 3.07 × 10⁻¹ | 165 |
| ester* | | | | | |
| RAS + 10% | 9.03 × 10² | 3.94 × 10¹ | 1.53 × 10⁰ | 1.07 × 10⁻¹ | 145 |
| TOFA* | | | | | |
| RAS + 10% blend | 5.56 × 10² | 2.84 × 10¹ | 1.37 × 10⁰ | 1.04 × 10⁻¹ | 144** |
| (75:25) of TOFA + | | | | | |
| polyol ester | | | | | |

*Comparative examples
**Calculated value = 150° C.
^{‡}Values reported on unaged samples

As shown, aged binder recovered from reclaimed asphalt shingles (RAS) requires heating to 174° C. to achieve the targeted high-temperature criteria of G*/sin δ at 10 rad/s=1.0 kPa. Addition of 10 wt. % of a rheology modifier, e.g., polyol ester additive or fatty acid, reduces the temperature required for meeting the rheological high-temperature criteria.

The example with 10 wt. % of a 75:25 (w/w) blend of fatty acid and polyol ester additive shows a greater impact on reducing the temperature at which the high-temperature criteria is satisfied when compared with either rheology modifier alone. Based on gravimetric considerations, the calculated value for meeting the criteria with the 75:25 blend is 150° C. (e.g., 0.75(145° C.)+0.25(165° C.)=150° C.). However, the blend actually meets the high-temperature criteria at 144° C., or 6° C. less than expected. The results indicate that using the blend can be more effective than using either rheology modifier alone.

Tables 2 and 3 summarize the intermediate-temperature performance results. As shown in Table 2, the recovered RAS binder meets the rheological requirement (e.g., G*sin δ at 10 rad/s=5.0×106 Pa) only at 46.7° C., which is unacceptably high when the goal is about 20° C. Inclusion of 10 wt. % of either polyol ester additive or fatty acid gets close to the goal, in each case meeting the required value for G*sin δ at 22.8° C. However, when a 75:25 blend of fatty acid and polyol ester additive is used, the intermediate-temperature criteria can be met at least full six degrees lower (16.8° C.), again demonstrating substantial synergy from the blend.

Table 3 shows the values of G* (complex viscosity, in pascals) as a function of temperature in the working range of 10° C. to 60° C. As expected, the recovered RAS binder has the highest values of G* throughout the working temperature range. Inclusion of 10% polyol ester additive or 10% fatty acid provides a desirable reduction in G*. A commercial product (Hydrogreen™ rejuvenator from Green Asphalt Technologies) provides a similar reduction in G* when used at 10 wt. %. However, a shift to even lower values of G* at any given temperature within the working range is achieved with the 75:25 blend of fatty acid and polyol ester additive. This shift is unexpected and demonstrates a desirable synergy between the polyol ester and the tall oil fatty acid. The results indicate that less of the blend will be needed to push a recovered RAS binder to useful stiffness compared with either the polyol ester or the unsaturated fatty acid alone.

Modified bituminous binder can be used to improve the high-temperature performance of certain grades of asphalt binders. Table 4 compares G* values measured from two modified performance-grade binders. The PG 64-22 binder modified with 20 wt. % of RAP binder is shown as it is common practice for asphalt manufacturers to utilize up to 20% RAP without the aid of a rejuvenator.

It was found that an additional 20 wt. % of RAS binder can be included in this blend if a small proportion (400 ppm) of a rheology modifier (combination of 75 wt. % fatty acid and 25 wt. % polyol ester) is also included. As shown in Table 4, the higher values of G* in the range of 30° C. to 70° C. for the RAS containing mix indicate greater stiffness than the 20% RAP mix at these temperatures. However, the lower values of G* in the range of −10° C. to 20° for the RAS containing mix indicate less stiffness than the 20% RAP mix at lower temperatures, despite the addition of 20 wt. % RAS to the blend.

Table 5 shows that addition of RAS to the PG 64-22/RAP blend allows the high-temperature criteria to be met at a higher temperature (8° C. increase in temperature at G*/sin δ=1.0×103 Pa) while also allowing the intermediate-temperature criteria to be met at a lower temperature (2° C. decrease in temperature at G*sin δ=5.0×106 Pa). The results in Tables 4 and 5 suggest an improvement in rutting resistance from the blend containing RAS with as good or better fatigue and low-temperature performance.

TABLE 5
Summary of Dynamic Shear Rheometry Results

| | High-Temperature Criteria | Fatigue Criteria |
|---|---|---|
| | Temperature at which G*/sin δ at | Temperature at which G*sin δ at |
| | 10 rad/s = 1000 Pa (° C.) | 10 rad/s = 5.0 × 10⁶ Pa (° C.) |
| PG 64-22 binder + RAP binder | 72 | 19 |
| (80:20 w/w)* | | |
| PG 64-22 binder + RAP binder + | 78 | 17 |
| RAS binder (60:20:20 w/w) and | | |
| 400 ppm added rheology | | |
| modifier | | |
| Observations: | Can improve rutting resistance | Rutting resistance is improved |
| | by +6° C. by including RAS | without sacrificing fatigue |
| | binder + rheology modifier. | performance. |

*Comparative example

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k(RU−RL), where k is a variable ranging from 1% to 100% with a 1% increment, e.g., k is 1%, 2%, 3%, 4%, 5% . . . . 50%, 51%, 52% . . . . 95%, 96%, 97%, 98%, 99%, or 100%. Moreover, any numerical range represented by any two values of R, as calculated above is also specifically disclosed. Any modifications, in addition to those shown and described herein, will become apparent to those skilled in the art from the foregoing description and accompanying drawings. Such modifications are intended to fall within the scope of the appended claims. All publications cited herein are incorporated by reference in their entirety.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the disclosure and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art. Publications cited herein and the materials for which they are cited are specifically incorporated by reference.

TABLE 2
Summary of Dynamic Shear Rheometry Results: Intermediate-Temperature Performance ‡

| | | | | | | | Temperature at which |
|---|---|---|---|---|---|---|---|
| | Value of G*sin δ (Pa) at temperatures 10-60° C. | | | | | | G*sin δ at 10 rad/s = |
| | 10° C. | 20° C. | 30° C. | 40° C. | 50° C. | 60° C. | 5.0 × 10⁶ Pa (° C.) |
| RAS* | 2.62 × 10⁷ | 1.70 × 10⁷ | 1.07 × 10⁷ | 6.50 × 10⁶ | 3.81 × 10⁶ | 2.11 × 10⁶ | 46.7 |
| RAS + 10% polyol | 9.33 × 10⁶ | 5.26 × 10⁶ | 2.95 × 10⁶ | 1.65 × 10⁶ | 8.93 × 10⁵ | 4.67 × 10⁵ | 22.8 |
| ester* | | | | | | | |
| RAS + 10% | 9.63 × 10⁶ | 5.27 × 10⁶ | 2.85 × 10⁶ | 1.49 × 10⁶ | 7.50 × 10⁵ | 3.57 × 10⁵ | 22.8 |
| TOFA* | | | | | | | |
| RAS + 10% blend | 7.08 × 10⁶ | 3.77 × 10⁶ | 2.02 × 10⁶ | 1.05 × 10⁶ | 5.21 × 10⁵ | 2.38 × 10⁵ | 16.8 |
| (75:25) of TOFA + | | | | | | | |
| polyol ester | | | | | | | |

*Comparative examples
‡ Values reported on unaged samples

TABLE 3
Summary of Dynamic Shear Rheometry Results: Intermediate-Temperature Performance ‡

| | Value of G* (Pa) as a function of Temperature (10-60° C.) | | | | | |
|---|---|---|---|---|---|---|
| | 10° C. | 20° C. | 30° C. | 40° C. | 50° C. | 60° C. |
| RAS* | 9.38 × 10⁷ | 5.41 × 10⁷ | 3.06 × 10⁷ | 1.67 × 10⁷ | 8.79 × 10⁶ | 4.44 × 10⁶ |
| RAS + 10% polyol ester* | 2.51 × 10⁷ | 1.31 × 10⁷ | 6.89 × 10⁶ | 3.50 × 10⁶ | 1.74 × 10⁶ | 8.22 × 10⁵ |
| RAS + 10% TOFA* | 2.43 × 10⁷ | 1.22 × 10⁷ | 6.00 × 10⁶ | 2.88 × 10⁶ | 1.32 × 10⁶ | 5.68 × 10⁵ |
| RAS + 10% Hydrogreen* | 2.84 × 10⁷ | 1.34 × 10⁷ | 6.34 × 10⁶ | 2.94 × 10⁶ | 1.31 × 10⁶ | 5.36 × 10⁵ |
| RAS + 10% blend (75:25) of | 1.79 × 10⁷ | 8.63 × 10⁶ | 4.20 × 10⁶ | 1.99 × 10⁶ | 8.93 × 10⁵ | 3.64 × 10⁵ |
| TOFA + polyol ester | | | | | | |

*Comparative examples
‡ Values reported on unaged samples

TABLE 4
Summary of Dynamic Shear Rheometry Results: Intermediate Temperature Performance of
PG 64-22 Blends with 20% RAP vs. blends with 20% RAP + 20% RAS + rheology modifier ‡

| | Value of G* (Pa) as a function of Temperature (−10° C. to 70° C.) | | | | | | | | |
|---|---|---|---|---|---|---|---|---|---|
| | −10° C. | 0° C. | 10° C. | 20° C. | 30° C. | 40° C. | 50° C. | 60° C. | 70° C. |
| PG 64-22 binder + RAP | 2.0 × 10⁸ | 8.0 × 10⁷ | 2.8 × 10⁷ | 5.5 × 10⁶ | 6.0 × 10⁵ | 1.0 × 10⁵ | 2.0 × 10⁴ | 5.0 × 10³ | 1.6 × 10³ |
| binder (80:20 w/w)* | | | | | | | | | |
| PG 64-22 binder + RAP | 1.8 × 10⁸ | 7.0 × 10⁷ | 2.0 × 10⁷ | 3.5 × 10⁶ | 7.0 × 10⁵ | 1.5 × 10⁵ | 3.3 × 10⁴ | 7.0 × 10³ | 2.5 × 10³ |
| binder + RAS binder | | | | | | | | | |
| (60:20:20 w/w) and 400 | | | | | | | | | |
| ppm added rheology | | | | | | | | | |
| modifier | | | | | | | | | |

RAS = reclaimed asphalt shingle binder; rheology modifier = 75/25 (w/w) TOFA to polyol ester.
*Comparative example
‡ Values reported on unaged samples

We claim:

1. A binder composition comprising:
(a) a bituminous binder; and
(b) 0.05 to 20 wt. %, based on the amount of binder composition, of a rheology modifier which comprises: (i) 5-50 wt. %, based on the amount of rheology modifier, of a polyol ester, and (ii) a C₈-C₂₄ free fatty acid component having an acid value of at least 180 mg KOH/g.

2. The binder composition of claim 1, wherein the bituminous binder comprises reclaimed asphalt pavement binder, reclaimed asphalt shingle binder, or a mixture thereof, optionally in combination with a virgin binder or a performance-grade binder.

3. The binder composition of claim 1, wherein the rheology modifier comprises 50 to 95 wt. % based on the amount of rheology modifier, of the C₈-C₂₄ free fatty acid component.

4. The binder composition of claim 1, wherein the rheology modifier comprises 10 to 50 wt. % based on the amount of rheology modifier, of the polyol ester and wherein the polyol ester derives from a thermally stable polyol and at least one molar equivalent of a C8-C24 fatty acid.

5. The binder composition of claim 1, wherein the polyol ester is selected from the group consisting of triethylolpropane, trimethylolpropane, neopentyl glycol, pentaerythritol, trimethylolpropane tallate, ethylene glycol Monomerate, neopentyl glycol Monomerate, 2-ethylhexyl Monomerate, and glycerol Monomerate, and mixtures thereof.

6. The binder composition of claim 1, wherein the C₈-C₂₄ free fatty acid component is a tall oil fatty acid.

7. The binder composition of claim 1, wherein the rheology modifier has an acid value within the range of 100 to 190 mg KOH/g.

8. The binder composition of claim 1, wherein the rheology modifier has an iodine value in the range of 110 to 160 mg 12/g.

9. The binder composition of claim 1, wherein the bituminous binder comprises 10-100% of reclaimed asphalt shingle binder.

10. The binder composition of claim 1, comprising 50 to 70 wt. % of a performance-grade binder, 0.05 to 20 wt. %, based on the amount of binder composition, of the rheology modifier, and remainder a bituminous binder consisting essentially of reclaimed asphalt shingle binder.

11. An asphalt composition comprising aggregate and the binder composition of claim 1.

12. A paved road surface, road subsurface, runway, driveway, parking lot, road shoulder, bridge, bridge abutment, or unpaved road comprising the asphalt composition of claim 11.

13. An asphalt emulsion composition comprising: a) an aqueous phase comprising at least an emulsifying agent, and b) a dispersion phase comprising a bituminous binder and 0.05 to 20 wt. %, based on the amount of bituminous binder, of a rheology modifier which comprises: (i) 5-50 wt. %, based on the amount of rheology modifier, of a polyol ester, and (ii) a C₈-C₂₄ free fatty acid component having an acid value of at least 180 mg KOH/g.

14. The asphalt emulsion composition of claim 13, wherein the free fatty acid component has an acid value of at least 190 mg KOH/g.

15. The asphalt emulsion composition of claim 13, wherein the polyol ester derives from a thermally stable polyol and at least one molar equivalent of a C₈-C₂₄ fatty acid.

16. The asphalt emulsion composition of claim 13, wherein the thermally stable polyol is selected from the group consisting of triethylolpropane, trimethylolpropane, neopentyl glycol, pentaerythritol, and mixtures thereof.

17. The asphalt emulsion composition of claim 13, wherein the rheology modifier is present in an amount of 0.1 to 15 wt. % of the total weight of the asphalt emulsion.

18. The asphalt emulsion composition of claim 13, wherein the bituminous binder is present in an amount of 20 to 70 wt. % of the total weight of the asphalt emulsion.

19. The asphalt emulsion composition of claim 13, wherein the aqueous phase further comprises an acrylic polymer or copolymer.

20. A method for rejuvenating asphalt pavement comprising:
applying to the asphalt pavement a composition comprising an aqueous emulsion of at least an emulsifying agent, a bituminous binder; and 0.05 to 20 wt. %, based on the amount of bituminous binder, of a rheology modifier which comprises: (i) 5-50 wt. %, based on the amount of rheology modifier, of a polyol ester, and (ii) a C₈-C₂₄ free fatty acid component having an acid value of at least 180 mg KOH/g, and
drying the aqueous emulsion.
